(19) United States
(12) Patent Application Publication
(10) Pub. No.: US 2014/0163793 A1
(43) Pub. Date: Jun. 12, 2014

(54) METHOD AND SYSTEM FOR CONTROLLING AN ENGINE START FOR HYBRID VEHICLE WHEN A STARTER MOTOR IS IN TROUBLE

(71) Applicants: Kia Motors Corporation, Seoul (KR); Hyundai Motor Company, Seoul (KR)

(72) Inventors: Sang Joon Kim, Seoul (KR); Tae Woo Kim, Hwaseong (KR)

(73) Assignees: KIA MOTORS CORPORATION, Seoul (KR); HYUNDAI MOTOR COMPANY, Seoul (KR)

(21) Appl. No.: 14/068,327

(22) Filed: Oct. 31, 2013

(30) Foreign Application Priority Data
Dec. 7, 2012 (KR) 10-2012-0142065

(51) Int. Cl. B60W 20/00

(52) U.S. Cl. CPC B60W 20/10; Y10S 903/902
USPC 701/22; 180/65.22; 903/902

(57) ABSTRACT

Disclosed herein is a method and system for controlling an engine start when a starter motor of a hybrid vehicle is in trouble. The method of controlling an engine start for a hybrid vehicle includes: determining whether a starter motor is in trouble when an engine start is requested, slip-controlling the transmission clutch for torque of the motor and the engine and transmission torque of the transmission to become independent of one another while starting the engine by the motor when the starter motor is in trouble, controlling the motor to generate driving power needed to start the engine when the slip-control of the transmission clutch is started, and starting the engine while controlling pressure of the engine clutch so that the driving power of the motor may be transmitted to the engine.

### CROSS-REFERENCE TO RELATED APPLICATION

This application claims priority to and the benefit of Korean Patent Application No. 10-2012-0142065 filed in the Korean Intellectual Property Office on Dec. 7, 2012, the entire contents of which are incorporated herein by reference.

### BACKGROUND

(a) Technical Field

The present disclosure relates to a method and a system for controlling an engine start when a starter motor of a hybrid vehicle is in trouble.

(b) Description of the Related Art

Hybrid electric vehicles operate through the use of power from an internal combustion engine and power from a battery. In particular, hybrid vehicles are designed to efficiently combine and use power of the internal combustion engine and the motor.

For example, as illustrated in FIG. 1, a hybrid vehicle includes an engine 10, a motor 20, an engine clutch 30, a transmission 40, a differential gear unit 50, a battery 60, an integrated starter-generator (ISG) 70, and wheels 80. The engine clutch 30 controls power transmission between the engine 10 and the motor 20, and the integrated starter-generator (ISG) 70 starts the engine 10 or generates electric power by output torque of the engine 10.

Although the integrated starter-generator 70 operates as a starter motor or a generator, because the integrated starter-generator 70 is associated with an engine start in the present disclosure, the integrated starter-generator 70 will be regarded as a starter motor in the description.

As further shown, the hybrid vehicle includes: a hybrid control unit (HCU) 200 which controls overall operation of the hybrid electric vehicle; an engine control unit (ECU) 110 which controls operation of the engine 10; a motor control unit (MCU) 120 which controls operation of the motor 20; a transmission control unit (TCU) 140 which controls operation of the transmission 40; and a battery control unit (BCU) 160 which manages and controls the battery 60. The battery control unit 160 may also be referred to as a battery management system (BMS). The integrated starter-generator 70 may also be referred to as a starting/generating motor or a hybrid starter-generator.

The hybrid vehicle may run in a driving mode, such as an electric vehicle (EV) mode only using power of the motor 20, a hybrid electric vehicle (HEV) mode using torque of the engine 10 as main power and torque of the motor 20 as auxiliary power, and a regenerative braking (RB) mode during braking or when the vehicle runs by inertia. In the RB mode, braking and inertia energy are collected through power generation of the motor 20, and the battery 60 is charged with the collected energy.

When the starter motor is in trouble, the hybrid vehicle may start the engine 10 using the motor 20 that provides driving power. For example, in a conventional method known in the related art, when the starter motor is in trouble, after the engine clutch is locked-up, the engine may be started by driving power of the motor. However, a shock due to the locking-up of the engine clutch or a shock due to a torque difference between the engine and the motor during initial fuel injection just after starting the engine is not considered, thereby worsening drivability.

The shock is transmitted to a driving shaft through the transmission. A relationship between driving shaft torque (T_driving), engine clutch torque (T_ec), motor torque (T_mot), and shock torque (T_disturbance) may be set as in the equation below:

T_driving=T_{—}ec+T_{—}mot+T_disturbance

The above information disclosed in this Background section is only for enhancement of understanding of the background of the disclosure, and therefore, it may contain information that does not form the related art that is already known to a person of ordinary skill in the art.

### SUMMARY

The disclosed embodiments have been made in an effort to provide a method and a system for controlling an engine start when a starter motor of a hybrid vehicle is in trouble. The disclosed embodiments have an advantage of preventing a shock generated when starting the engine from being transmitted to a driving shaft, by slip-controlling a transmission clutch which is installed in a transmission and connects a motor and an input shaft of the transmission while starting the engine by using the motor when the starter motor is in trouble.

The disclosed embodiments have also been made in an effort to provide a method and a system for controlling an engine start when a starter motor of a hybrid vehicle is in trouble, having an advantage of independently controlling output torque of a driving shaft and torque generated when starting the engine by slip-controlling a transmission clutch installed in a transmission while starting the engine through locking-up of an engine clutch when the starter motor is in trouble.

An exemplary embodiment of the present disclosure provides a method of controlling an engine start for a hybrid vehicle which includes an engine clutch controlling power transmission between an engine and a motor, and a transmission clutch connecting the motor and an input shaft of a transmission, the method including: determining whether a starter motor is in trouble when an engine start is requested, slip-controlling the transmission clutch for torque of the motor and the engine and transmission torque of the transmission to become independent of one another while starting the engine by the motor when the starter motor is in trouble, controlling the motor to generate driving power needed to start the engine when the slip-control of the transmission clutch is started, and starting the engine while controlling pressure of the engine clutch so that the driving power of the motor may be transmitted to the engine.

The slip-controlling of the transmission clutch may include controlling the transmission to equalize slip torque (T_tmclutch) of the transmission clutch and torque (T_driving) of a driving shaft. The controlling the motor may include increasing speed of the motor to a target speed needed to start the engine.

The method may further include controlling speed of the motor for a speed difference of both ends of the transmission clutch to become zero (0) when the engine has been started. The controlling of the motor may include providing demand torque of the motor feed-forwardly. The pressure of the engine clutch may be controlled to be increased in a stepwise manner.

Another exemplary embodiment of the present disclosure provides a system for controlling an engine start for a hybrid vehicle running by a combination of power of an engine and power of a motor, the system including: a starter motor configured to start the engine, an engine clutch configured to control power transmission between the engine and the motor, a transmission clutch configured to connect the motor and an input shaft of a transmission, wherein the transmission clutch is installed in the transmission, and a control unit configured to control the transmission clutch while starting the engine by the motor when the starter motor is in trouble, such that the control unit is operated by a predetermined program, and the predetermined program includes a series of commands for executing a method including: determining whether a starter motor is in trouble when an engine start is requested, slip-controlling the transmission clutch for torque of the motor and the engine and transmission torque of the transmission to become independent of one another while starting the engine by the motor when the starter motor is in trouble, controlling the motor to generate driving power needed to start the engine when the slip-control of the transmission clutch is started, and starting the engine while controlling pressure of the engine clutch so that the driving power of the motor may be transmitted to the engine. The control unit may include a proportional integral (PI) control unit configured to feedback control the motor.

As described above, according to an exemplary embodiment of the present disclosure, it is possible to prevent a shock generated when starting the engine from being transmitted to a driving shaft by slip-controlling a transmission clutch which is installed in a transmission and connects a motor and an input shaft of the transmission while starting the engine by using the motor when the starter motor is in trouble. Therefore, according to an exemplary embodiment of the present disclosure, it is possible to enhance drivability while starting the engine by using the motor when the starter motor is in trouble.

### BRIEF DESCRIPTION OF THE DRAWINGS

FIG. 1 is an exemplary schematic diagram illustrating a configuration of a typical hybrid vehicle.

FIG. 2 is an exemplary configuration diagram of a system for controlling engine start for a hybrid vehicle according to an exemplary embodiment of the present disclosure.

FIG. 3 is an exemplary flowchart of a method of controlling an engine start for a hybrid vehicle according to an exemplary embodiment of the present disclosure.

FIG. 4 is an exemplary graph for explaining control of a transmission clutch according to an exemplary embodiment of the present disclosure.

FIG. 5 is an exemplary graph for explaining control of an engine clutch according to an exemplary embodiment of the present disclosure.

FIG. 6 is an exemplary graph for explaining control of engine torque and motor torque according to an exemplary embodiment of the present disclosure.

FIG. 7 is an exemplary control configuration diagram for explaining speed control of a motor according to an exemplary embodiment of the present disclosure.

### DETAILED DESCRIPTION OF THE EMBODIMENTS

Hereinafter, exemplary embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below methods are executed by at least one control unit. The term “control unit” refers to a hardware device that includes a memory and a processor. The memory is configured to store program instructions and the processor is specifically configured to execute said program instructions to perform one or more processes which are described further below.

Furthermore, the control unit of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

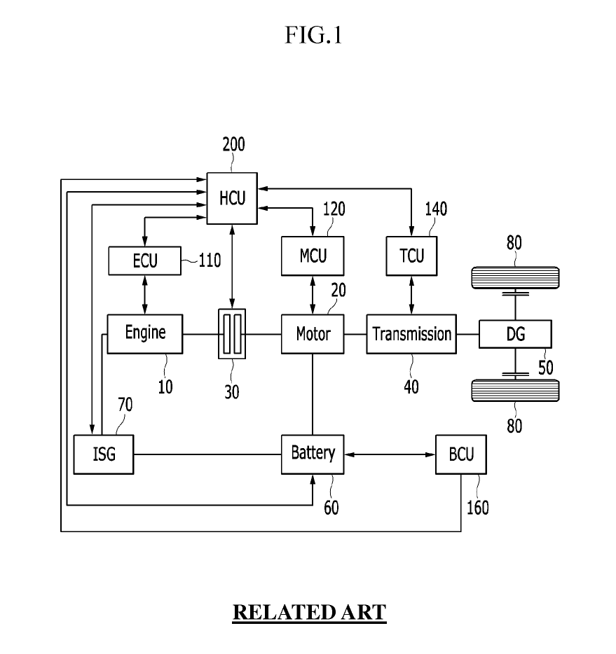

FIG. 1 is a schematic diagram illustrating a configuration of a typical hybrid vehicle to which a system for controlling engine start according to an exemplary embodiment of the present disclosure may be applied. As illustrated in FIG. 1, the typical hybrid vehicle may include an engine 10, a motor 20, an engine clutch 30 configured to control power transmission between the engine 10 and the motor 20, a transmission 40, a differential gear unit 50, a battery 60, and an integrated starter-generator (ISG) 70 configured to start the engine 10 or generate electric power by output of the engine 10. Although the integrated starter-generator 70 operates as a starter motor or a generator, because the integrated starter-generator 70 is associated with engine start in exemplary embodiments of the present disclosure, the integrated starter-generator 70 will be regarded and explained as a starter motor in the description below.

As further shown, the typical hybrid vehicle to which the system for controlling the engine start according to the exemplary embodiment of the present invention may be applied may include: a hybrid control unit (HCU) 200 which controls overall operation (including operation of the starter motor 70 and the engine clutch 30) of the hybrid electric vehicle; an engine control unit (ECU) 110 which controls operation of the engine 10; a motor control unit (MCU) 120 which controls operation of the motor 20; a transmission control unit (TCU) 140 which controls operation of the transmission 40; and a battery control unit (BCU) 160 which manages and controls the battery 60.

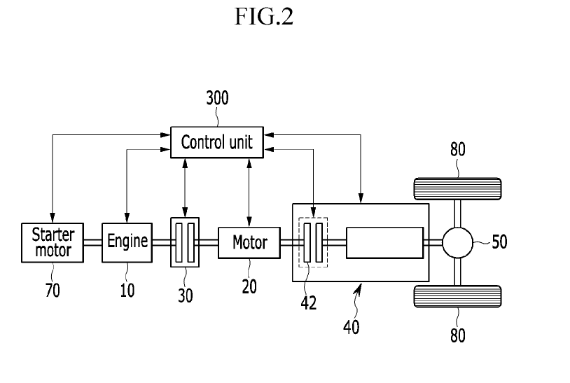

FIG. 2 is a configuration diagram of a system for controlling engine start for a hybrid vehicle according to an exemplary embodiment of the present disclosure. The system controls the engine start by using the motor when the starter motor is in trouble.

As shown in FIG. 2, the system for controlling the engine start for the hybrid vehicle according to the exemplary embodiment of the present disclosure includes: a starter motor 70 configured to start the engine 10; an engine clutch 30 configured to control power transmission between the engine 10 and the motor 20; a transmission clutch 42 configured to connect the motor 20 and an input shaft of a transmission 40, wherein the transmission clutch 42 is installed in the transmission 40; and a control unit 300 configured to control the transmission clutch 42 while starting the engine 10 by the motor 20 when the starter motor 70 is in trouble. Since the engine 10, the motor 20, the engine clutch 30, the transmission 40, the transmission clutch 42, and the starter motor 70 are generally installed in typical hybrid vehicles, their detailed description will be omitted in the present specification.

The control unit 300 may include one or more processors or microprocessors and/or hardware operated by a program including a series of commands for executing a method of controlling engine start for a hybrid vehicle according to an exemplary embodiment of the present disclosure which will be described below.

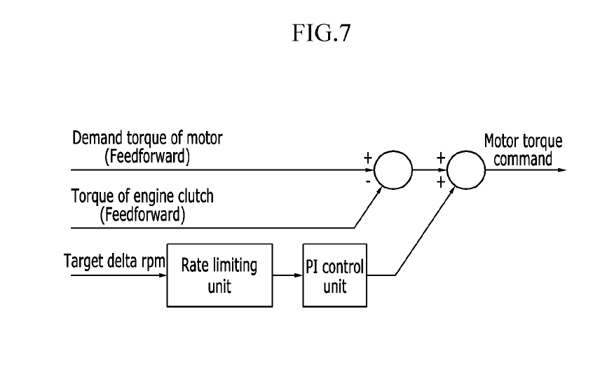

As illustrated in FIG. 7, the control unit 300 may include a rate limiting unit configured to limit a target delta RPM in controlling the motor 20, and a proportional integral (PI) control unit configured to feedback-control the motor 20 based on RPM via the rate limiting unit. In the exemplary embodiment of the present disclosure, the control unit 300 may include an engine control unit (ECU) for controlling operation of the engine 10 of the hybrid vehicle, a motor control unit (MCU) for controlling operation of the motor 20, a transmission control unit (TCU) for controlling operation of the transmission 40, and a hybrid control unit (HCU) for controlling general operation (including operation of the engine clutch 30 and the starter motor 70) of the hybrid vehicle, as illustrated in FIG. 1.

In the exemplary method of controlling the engine start according to the exemplary embodiment of the present disclosure which will be described below, some processes may be performed by the ECU, other processes may be performed by the MCU, and yet further processes may be performed by the TCU or the HCU. However, it should be understood that the scope of the present disclosure is not limited to the exemplary embodiment to be described below. The control unit may be implemented with a different combination from that described in the exemplary embodiment of the present disclosure. Therefore, the ECU, the MCU, the TCU, and the HCU may perform a different combination of processes from that described in the exemplary embodiment of the present disclosure.

Hereinafter, a method of controlling an engine start for a hybrid vehicle according to an exemplary embodiment of the present disclosure will be described in detail with reference to the accompanying drawings.

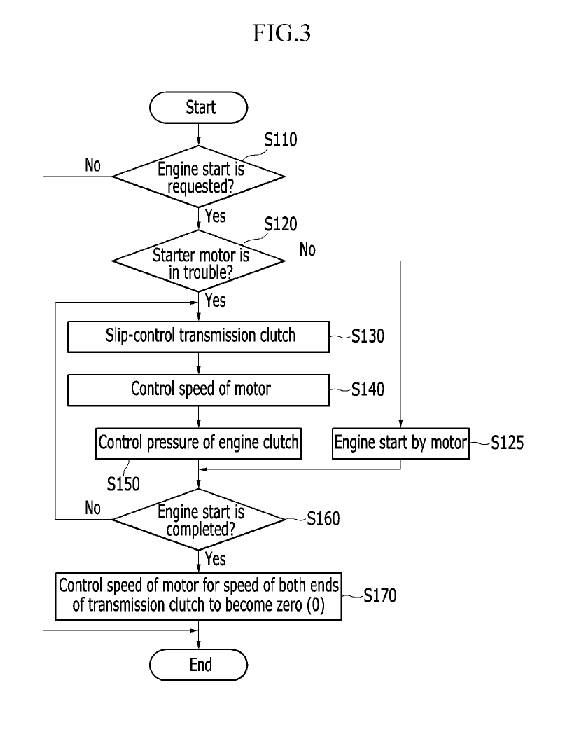

FIG. 3 is a flowchart of a method of controlling engine start for a hybrid vehicle according to an exemplary embodiment of the present disclosure. As illustrated in FIG. 3, the control unit 300 determines whether the engine start is requested at step S110.

In the exemplary embodiment of the present disclosure, the request for the engine start, for example, may include initially starting the engine 10 and changing the engine 10 from the EV mode to the HEV mode. In order to determine whether the engine start is requested, the control unit 300 may refer to a signal of the HCU 200, as illustrated in FIG. 1

Next, the control unit 300 determines whether the starter motor 70 is in trouble at step S120. The control unit 300 may determine whether the starter motor 70 is in trouble according to a typical method of determining trouble of the starter motor in the related art. For example, the control unit 300 may determine whether the starter motor 70 is in trouble by referring to a signal of the HCU 200 associated with the starter motor 70.

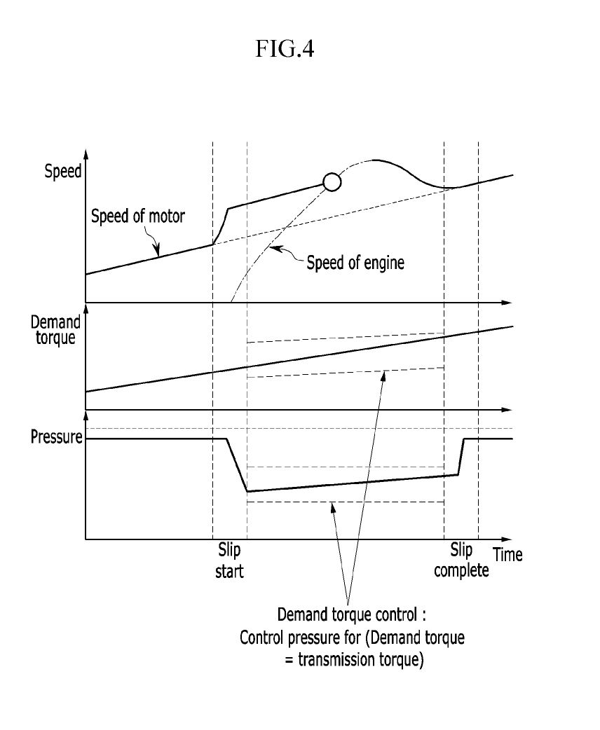

When the starter motor 70 is not in trouble at step S120, the control unit 300 starts the engine 10 by the starter motor 70 according to an existing method at step S125. However, when the starter motor 70 is in trouble at step S120, as illustrated in FIG. 4, the control unit 300 slip-controls the transmission clutch 42 at step S130.

By slip-controlling the transmission clutch 42, when the control unit 300 starts the engine 10 by the motor 20, slip torque (T_tmclutch) of the transmission clutch 42 may become equal to driving torque of the hybrid vehicle, that is, to torque (T_driving) of a driving shaft (T_driving=T_tmclutch). Because the control unit 300 slip-controls the transmission clutch 42, torque associated with the engine start by the motor 20 and the T_driving may be independent of each other. Accordingly, a problem of the related art expressed as in the following equation may be solved. In the following equation, T_ec is torque of the engine clutch, T_mot is torque of the motor, and T_disturbance is shock torque associated with fuel injection in the engine:

[Torque of a driving shaft according to the related art]=T_{—}ec+T_{—}mot+T_disturbance

Thus, according to the exemplary embodiment of the present disclosure, the negative shock torque (T_disturbance) transmitted to the driving shaft in the related art may be removed, thereby enhancing drivability. The slip-control for the transmission clutch 42 may be performed by controlling pressure supplied to the transmission clutch 42.

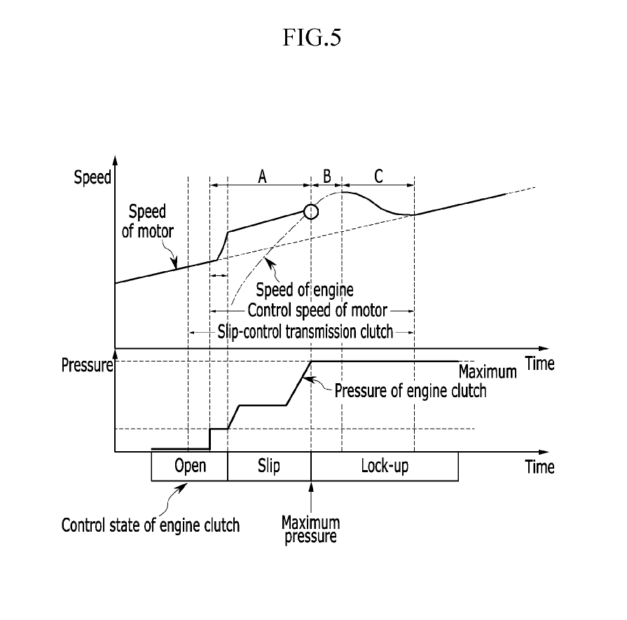

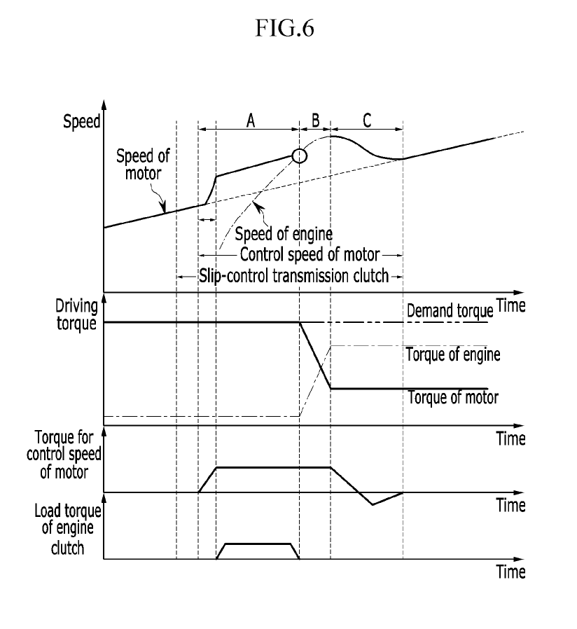

As illustrated in FIG. 5 and FIG. 6, when the transmission clutch 42 starts to slip, the control unit 300 controls speed of the motor 20 and pressure of the engine clutch 30 for starting the engine 10 at steps S140 and S150. Referring to FIG. 5 and FIG. 6, when the transmission clutch 42 starts to slip, the control unit 300 supplies the engine clutch 30 with pressure for locking up the engine clutch 30. When supplying the engine clutch 30 with pressure, the control unit 300 increases the pressure in a stepwise manner to prevent torque (T_ec) of the engine clutch from excessively varying. The control unit 300 sets pressure of the engine clutch 30 for the T_ec to be greater than friction torque of the engine 10, such that the engine start may be performed smoothly.

As further illustrated in FIG. 5 and FIG. 6, the maximum pressure of the engine clutch 30 is at a point in time when speeds of both ends of the engine clutch 30 are synchronized. After the pressure of the engine clutch 30 has become maximum pressure, the control unit 300 keeps the engine clutch 30 locked up. When the engine clutch 30 starts to slip according to supplying oil pressure, the control unit 300 increases the speed of the motor 20 to a target speed. Before the engine 10 is started, that is, before fuel injection is caused by cranking, the engine 10 works as a load. After fuel injection, the engine 10 becomes a target torque control object. While the engine 10 is being started, the control unit 300 may feed-forwardly control the motor 20 in order to output torque corresponding to an engine clutch load (T_ac) and a transmission clutch load (T_tmclutch).

When the engine 10 has been started by the motor 20 at step S160, the control unit 300 controls speed of the motor 20 so that a speed difference of both ends of the transmission clutch 42 may become zero (0), as illustrated in FIG. 6, at step S170. As illustrated in FIG. 7, the control unit 300 may control speed of the motor 20 through a proportional integral (PI) control unit so that the speed difference of both ends of the transmission clutch 42, that is, target delta RPM, may become zero (0).

Therefore, according to the exemplary embodiment of the present disclosure, it is possible to prevent the shock generated when starting the engine from being transmitted to the driving shaft by slip-controlling the transmission clutch while starting the engine with the motor.

While the contents of the present disclosure have been described in connection with what is presently considered to be exemplary embodiments, it is to be understood that the disclosure is not limited to the disclosed embodiments, but, on the contrary, is intended to cover various modifications and equivalent arrangements included within the spirit and scope of the appended claims.

<Description of Reference Numerals>

| | |
|---|---|
| 10: Engine | 20: Motor |
| 30: Engine clutch | 40: Transmission |
| 42: Transmission clutch | |
| 70: Starter motor (integrated starter-generator) | |
| 300: Control unit | |

What is claimed is:

1. A method of controlling an engine start for a hybrid vehicle which includes an engine clutch controlling power transmission between an engine and a motor, and a transmission clutch connecting the motor and an input shaft of a transmission, the method comprising:
determining, by a control unit, whether a starter motor is in trouble when an engine start is requested;
slip-controlling, by the control unit, the transmission clutch for torque of the motor and the engine and transmission torque of the transmission to become independent of one another while starting the engine by the motor when the starter motor is in trouble;
controlling, by the control unit, the motor to generate driving power needed to start the engine when the slip-control of the transmission clutch is started; and
starting, by the control unit, the engine while controlling pressure of the engine clutch so that the driving power of the motor may be transmitted to the engine.

2. The method of claim 1, wherein the slip-controlling of the transmission clutch comprises controlling the transmission to equalize slip torque (T_tmclutch) of the transmission clutch and torque (T_driving) of a driving shaft.

3. The method of claim 1, wherein the controlling of the motor comprises increasing speed of the motor to a target speed needed to start the engine.

4. The method of claim 1, further comprising controlling, by the control unit, speed of the motor for a speed difference of both ends of the transmission clutch to become zero (0) when the engine has been started.

5. The method of claim 1, wherein the controlling of the motor comprises providing demand torque of the motor feed-forwardly.

6. The method of claim 1, wherein the pressure of the engine clutch is controlled to be increased in a stepwise manner.

7. A system for controlling an engine start for a hybrid vehicle running by combination of power of an engine and power of a motor, the system comprising:
a starter motor configured to start the engine;
an engine clutch configured to control power transmission between the engine and the motor;
a transmission clutch configured to connect the motor and an input shaft of a transmission, wherein the transmission clutch is installed in the transmission; and
a control unit configured to control the transmission clutch while starting the engine by the motor when the starter motor is in trouble,
wherein the control unit is operated by a predetermined program, and the predetermined program includes a series of commands for executing a method of controlling an engine start for a hybrid vehicle, comprising:
determining whether a starter motor is in trouble when an engine start is requested;
slip-controlling the transmission clutch for torque of the motor and the engine and transmission torque of the transmission to become independent of one another while starting the engine by the motor when the starter motor is in trouble;
controlling the motor to generate driving power needed to start the engine when the slip-control of the transmission clutch is started; and
starting the engine while controlling pressure of the engine clutch so that the driving power of the motor may be transmitted to the engine.

8. The system of claim 7, wherein the slip-controlling of the transmission clutch comprises controlling the transmission to equalize slip torque (T_tmclutch) of the transmission clutch and torque (T_driving) of a driving shaft.

9. The system of claim 7, wherein the controlling of the motor comprises increasing speed of the motor to a target speed needed to start the engine.

10. The system of claim 7, further comprising controlling speed of the motor for a speed difference of both ends of the transmission clutch to become zero (0) when the engine has been started.

11. The system of claim 7, wherein the controlling of the motor comprises providing demand torque of the motor feed-forwardly.

12. The system of claim 7, wherein the pressure of the engine clutch is controlled to be increased in a stepwise manner.

13. The system of claim 7, wherein the control unit comprises a proportional integral (PI) control unit configured to provide feedback control the motor.

14. A non-transitory computer readable medium containing program instructions for controlling an engine start for a hybrid vehicle, which includes an engine clutch controlling power transmission between an engine and a motor, and a transmission clutch connecting the motor and an input shaft of a transmission, the computer readable medium comprising:
program instructions that determine whether a starter motor is in trouble when an engine start is requested;
program instructions that slip-control the transmission clutch for torque of the motor and the engine and transmission torque of the transmission to become independent of one another while starting the engine by the motor when the starter motor is in trouble;
program instructions that control the motor to generate driving power needed to start the engine when the slip-control of the transmission clutch is started; and
program instructions that start the engine while controlling pressure of the engine clutch so that the driving power of the motor may be transmitted to the engine.

15. The computer readable medium of claim 14, wherein the program instructions that slip-control the transmission clutch comprise program instructions that control the transmission to equalize slip torque (T_tmclutch) of the transmission clutch and torque (T_driving) of a driving shaft.

16. The computer readable medium of claim 14, wherein the program instructions that control the motor comprise program instructions that increase speed of the motor to a target speed needed to start the engine.

17. The computer readable medium of claim 14, further comprising program instructions that control speed of the motor for a speed difference of both ends of the transmission clutch to become zero (0) when the engine has been started.

18. The computer readable medium of claim 14, wherein the program instructions that control the motor comprise program instructions that provide demand torque of the motor feed-forwardly.

19. The computer readable medium of claim 14, wherein the pressure of the engine clutch is controlled to be increased in a stepwise manner.
